(19) United States
(12) Patent Application Publication
(10) Pub. No.: US 2026/0024693 A1
(43) Pub. Date: Jan. 22, 2026

(54) LAYERED STRUCTURE AND INDUCTOR

(71) Applicant: ADVANTEST CORPORATION, Tokyo (JP)

(72) Inventors: Fumikazu TAKAYANAGI, Miyagi (JP); Bunichi KAKINUMA, Miyagi (JP)

(73) Assignee: ADVANTEST CORPORATION, Tokyo (JP)

(21) Appl. No.: 19/220,378

(22) Filed: May 28, 2025

(30) Foreign Application Priority Data
Jul. 17, 2024 (JP) 2024-114110

(51) Int. Cl. H01F 27/24; H01F 1/12

(52) U.S. Cl. CPC H01F 27/24; H01F 1/12

(57) ABSTRACT

A layered structure includes a non-magnetic layer, an upper soft magnetic layer, a lower soft magnetic layer, and a coupling soft magnetic layer. The upper soft magnetic layer is in contact with atop surface of the non-magnetic layer. The lower soft magnetic layer is in contact with a bottom surface of the non-magnetic layer. The coupling soft magnetic layer is coupled to the upper soft magnetic layer and the lower soft magnetic layer. The coupling soft magnetic layer is in contact with a first side surface and a second side surface of the non-magnetic layer. The first side surface and the second side surface are spaced from each other.

### BACKGROUND OF THE INVENTION

### Field of the Invention

The present invention relates to an inductor core.

### Description of the Related Art

There have conventionally been known layered structures in which a magnetic layer and a non-magnetic layer are laminated (see Japanese Patent Application Publication Nos. 2021-015909, 2023-136104, and 2011-014919, for example). It is also known to utilize such a layered structure as an inductor core.

### SUMMARY OF THE INVENTION

However, even when a magnetic field may be applied externally in the longitudinal direction of such a layered structure according to the above-described related art, if the magnetic field is low, the magnetization in the layered structure does not change to be constant at zero.

It is hence an object of the present invention to prevent the magnetization in a layered structure in which a magnetic layer and a non-magnetic layer are laminated from becoming constant at zero when a magnetic field may be applied externally in the longitudinal direction of the layered structure.

According to the present invention, a layered structure includes: a non-magnetic layer; an upper soft magnetic layer in contact with a top surface of the non-magnetic layer; a lower soft magnetic layer in contact with a bottom surface of the non-magnetic layer; and a coupling soft magnetic layer that is coupled to the upper soft magnetic layer and the lower soft magnetic layer, wherein the coupling soft magnetic layer is in contact with a first side surface and a second side surface of the non-magnetic layer, and the first side surface and the second side surface are spaced from each other.

According to the thus configured layered structure includes a non-magnetic layer. An upper soft magnetic layer is in contact with atop surface of the non-magnetic layer. A lower soft magnetic layer is in contact with a bottom surface of the non-magnetic layer. A coupling soft magnetic layer is coupled to the upper soft magnetic layer and the lower soft magnetic layer. The coupling soft magnetic layer is in contact with a first side surface and a second side surface of the non-magnetic layer. The first side surface and the second side surface are spaced from each other.

According to the layered structure of the present invention, the non-magnetic layer may be a single layer.

According to the layered structure of the present invention, the non-magnetic layer may have an uppermost non-magnetic layer and a lowermost non-magnetic layer, the upper soft magnetic layer may be in contact with a top surface of the uppermost non-magnetic layer, and the lower soft magnetic layer may be in contact with a bottom surface of the lowermost non-magnetic layer.

According to the layered structure of the present invention, the layered structure may extend in a longitudinal direction, and the longitudinal direction may intersect both of a normal direction of the top surface or the bottom surface and a normal direction of the first side surface or the second side surface.

According to the layered structure of the present invention, the longitudinal direction may be linear.

According to the layered structure of the present invention, the longitudinal direction may be curved.

According to the layered structure of the present invention, the layered structure may be annular, the first side surface may be arranged on an inner side, and the second side surface may be arranged on an outer side.

According to the layered structure of the present invention, the coupling soft magnetic layer may be in contact entirely with the first side surface and the second side surface.

According to the layered structure of the present invention, the coupling soft magnetic layer may be in contact partially with the first side surface and the second side surface.

According to the layered structure of the present invention, the non-magnetic layer may have a plurality of end faces that intersect the top surface, the bottom surface, the first side surface, and the second side surface, and any one or more of the end faces may be exposed.

According to the present invention, an inductor may include the layered structure according to the present invention used as a core.

### BRIEF DESCRIPTION OF THE DRAWINGS

FIGS. 1 (a) and 1 (b) are a perspective view (FIG. 1 (a)) and a b-b cross-sectional view (FIG. 1 (b)) of a layered structure 1 according to a first embodiment of the present invention;

FIG. 2 shows a magnetization direction M1 when an external magnetic field applied to the layered structure 1 is zero;

FIG. 3 schematically shows a correspondence between the external magnetic field applied to the layered structure 1 and the magnetization of the layered structure 1;

FIGS. 4 (a) and 4 (b) are a plan view (FIG. 4 (a)) and a b-b cross-sectional view (FIG. 4 (b)) of a layered structure 1 according to a first variation of the first embodiment;

FIG. 5 is a b-b cross-sectional view of a layered structure 1 according to a second variation of the first embodiment;

FIG. 6 is a b-b cross-sectional view of a layered structure 1 according to a third variation of the first embodiment;

FIGS. 7 (a) and 7 (b) are a plan view (FIG. 7 (a)) and a b-b cross-sectional view (FIG. 7 (b)) of a layered structure 1 according to a second embodiment of the present invention;

FIGS. 8 (a) and 8 (b) are a plan view (FIG. 8 (a)) and a b-b cross-sectional view (FIG. 8 (b)) of a layered structure 1 according to a variation of the second embodiment;

FIG. 9 is a plan view of a layered structure 1 according to a third embodiment of the present invention;

FIG. 10 is a plan view of a layered structure 1 according to a variation of the third embodiment;

FIGS. 11 (b), 11 (b), and 11 (c) are a perspective view (FIG. 11 (a)), a b-b cross-sectional view (FIG. 11 (b)), and a c-c cross-sectional view (FIG. 11 (c)) of a layered structure 1 according to the fourth embodiment of the present invention;

FIGS. 12 (a) and 12 (b) are a perspective view (FIG. 12 (a)) and a b-b cross-sectional view (FIG. 12 (b)) of a layered structure 2 (comparative example); and

FIG. 13 schematically shows a correspondence between an external magnetic field applied to the layered structure 2 (comparative example) and a magnetization of the layered structure 2 (comparative example).

### DESCRIPTION OF THE PREFERRED EMBODIMENT

Preferred embodiments of the present invention will hereinafter be described with reference to the accompanying drawings.

### First Embodiment

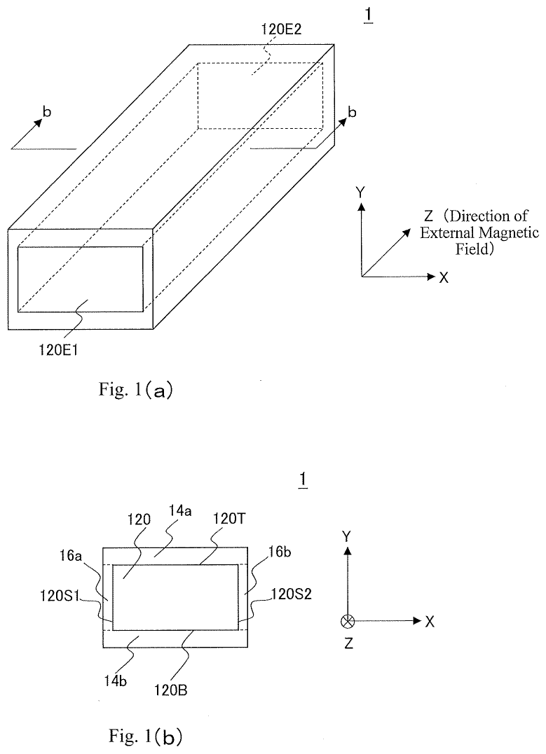

FIGS. 1 (a) and 1 (b) are a perspective view (FIG. 1 (a)) and a b-b cross-sectional view (FIG. 1 (b)) of a layered structure 1 according to a first embodiment of the present invention. It is noted that in FIG. 1, the X direction corresponds to the width direction of the layered structure 1, the Y direction corresponds to the height direction of the layered structure 1, and the Z direction corresponds to the depth direction (longitudinal direction) of the layered structure 1. It is also noted that the X, Y, and Z directions are orthogonal to each other. Also, a magnetic field is applied from outside the layered structure 1 in the Z direction. The b-b cross-sectional view is taken on the layered structure 1 along the XY plane.

The layered structure 1 according to the first embodiment includes a non-magnetic layer 120, an upper soft magnetic layer 14a, a lower soft magnetic layer 14b, and coupling soft magnetic layers 16a, 16b. The layered structure 1 according to the first embodiment may be used as an inductor core.

The non-magnetic layer 120 is a layer of non-magnetic material (e.g. diamagnetic material (e.g. copper or zinc) or paramagnetic material (e.g. aluminum or platinum)). The non-magnetic layer 120 is, for example, a layer of copper. It is noted that the non-magnetic layer 120 is a single layer.

The non-magnetic layer 120 has a top surface 120T, a bottom surface 120B, a first side surface 120S1, a second side surface 120S2, an end face 120E1, and an end face 120E2. The first side surface 120S1 and the second side surface 120S2 are spaced from each other. Both of the end face 120E1 and the end face 120E2 are exposed and visible externally. The end face 120E1 and the end face 120E2 have a normal direction in the Z direction. The non-magnetic layer 120 thus has the multiple end faces 120E1, 120E2 that intersect the top surface 120T, the bottom surface 120B, the first side surface 120S1, and the second side surface 120S2.

It is noted that the non-magnetic layer 120 is a rectangular parallelepiped in which the top surface 120T and the bottom surface 120B are parallel to each other, the first side surface 120S1 and the second side surface 120S2 are parallel to each other, and the end face 120E1 and the end face 120E2 are parallel to each other.

The top surface 120T and the bottom surface 120B have a normal direction in the Y direction. The first side surface 120S1 and the second side surface 120S2 have a normal direction in the X direction. The longitudinal direction Z intersects both of the X direction and the Y direction. The layered structure 1 extends in the longitudinal direction Z. The longitudinal direction Z is linear.

The upper soft magnetic layer 14a is in contact with the top surface 120T of the non-magnetic layer 120. The lower soft magnetic layer 14b is in contact with the bottom surface 120B of the non-magnetic layer 120.

The coupling soft magnetic layers 16a, 16b are coupled to the upper soft magnetic layer 14a and the lower soft magnetic layer 14b. The coupling soft magnetic layer 16a is in contact entirely with the first side surface 120S1 of the non-magnetic layer 120. The coupling soft magnetic layer 16b is in contact entirely with the second side surface 120S2 of the non-magnetic layer 120. That is, the coupling soft magnetic layers 16a, 16b are in contact entirely with the first side surface 120S1 and the second side surface 120S2.

It is noted that the upper soft magnetic layer 14a, the lower soft magnetic layer 14b, the coupling soft magnetic layer 16a, and the coupling soft magnetic layer 16b may be formed integrally as a soft magnetic body (of Co—Fe-based alloy, iron, nickel, cobalt, for example). In this case, for example, the Co—Fe-based alloy may wrap around the copper (non-magnetic layer 120).

Next will be described an operation according to the first embodiment.

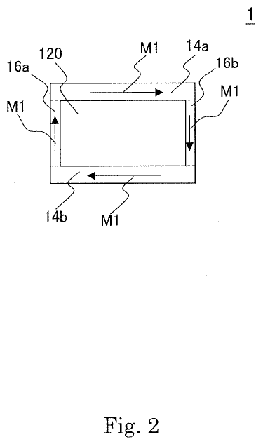

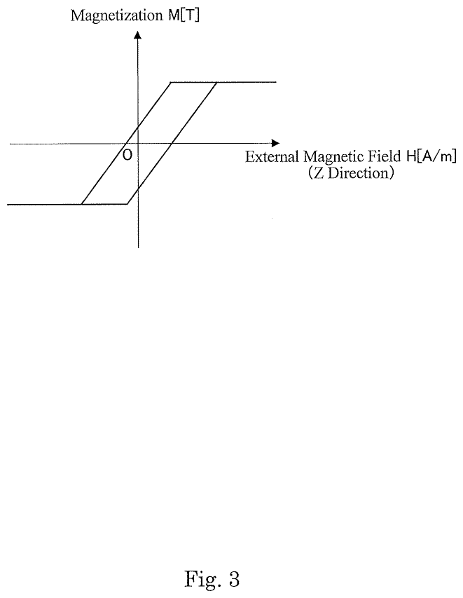

FIG. 2 shows a magnetization direction M1 when an external magnetic field applied to the layered structure 1 is zero. Note here that FIG. 2 corresponds to FIG. 1 (b). FIG. 3 schematically shows a correspondence between the external magnetic field applied to the layered structure 1 and the magnetization of the layered structure 1.

Since the left end of the upper soft magnetic layer 14a and the left end of the lower soft magnetic layer 14b are connected to the coupling soft magnetic layer 16a and the right end of the upper soft magnetic layer 14a and the right end of the lower soft magnetic layer 14b are connected to the coupling soft magnetic layer 16b, the soft magnetic body (the upper soft magnetic layer 14a, the lower soft magnetic layer 14b, the coupling soft magnetic layer 16a, and the coupling soft magnetic layer 16b) has an annular shape (toroidal shape) in the b-b cross-section of the layered structure 1 (see FIGS. 1 (b) and 2). Since this causes the diamagnetic field coefficient in the width direction (the X direction) of the layered structure 1 to be approximately zero, the magnetization is most likely to occur in the width direction (the X direction).

Accordingly, with reference to FIG. 2, when the external magnetic field applied to the layered structure 1 is zero, the magnetization direction M1 is clockwise around the soft magnetic body (+X direction in the upper soft magnetic layer 14a, −Y direction in the coupling soft magnetic layer 16b, −X direction in the lower soft magnetic layer 14b, +Y direction in the coupling soft magnetic layer 16a), and is perpendicular to the direction (the Z direction) in which the external magnetic field is applied.

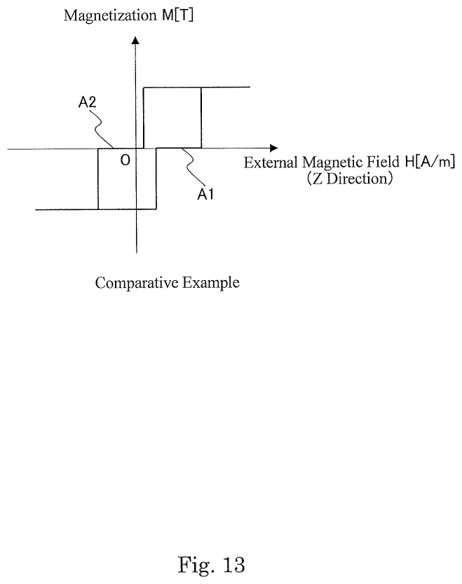

Here, when a magnetic field is applied externally to the layered structure 1 in the Z direction, there is no need to break the stabilized magnetization (in the magnetization direction M1) and therefore, with reference to FIG. 3, there is no area where the magnetization M in the layered structure 1 is constant at zero (see the areas A1, A2 in FIG. 13), and the magnetization M changes linearly with respect to the external magnetic field H.

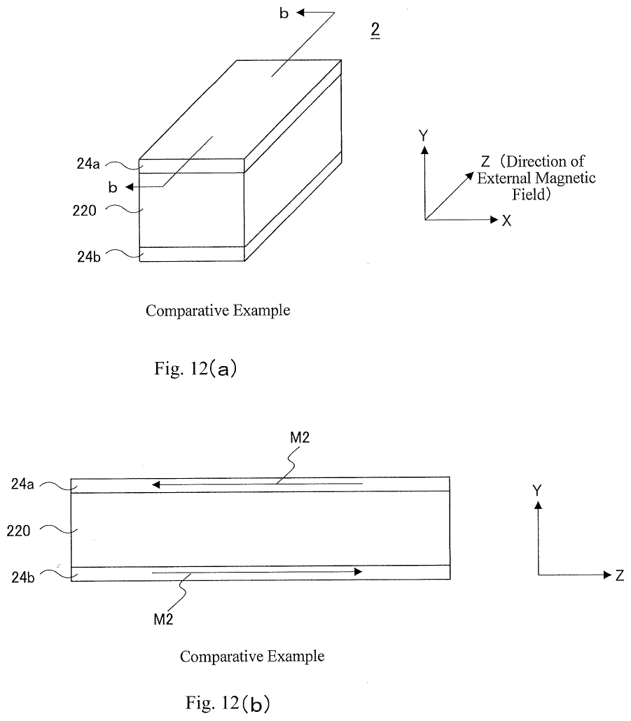

FIGS. 12 (a) and 12 (b) are a perspective view (FIG. 12 (a)) and a b-b cross-sectional view (FIG. 12 (b)) of a layered structure 2 (comparative example). It is noted that the b-b cross-section is taken on the layered structure 2 (comparative example) along the YZ plane. FIG. 13 schematically shows a correspondence between an external magnetic field applied to the layered structure 2 (comparative example) and the magnetization of the layered structure 2 (comparative example).

The layered structure 2 (comparative example) shown in FIG. 12 includes a non-magnetic layer 220, an upper soft magnetic layer 24a, and a lower soft magnetic layer 24b. The non-magnetic layer 220, the upper soft magnetic layer 24a, and the lower soft magnetic layer 24b are, respectively, identical to the non-magnetic layer 120, the upper soft magnetic layer 14a, and the lower soft magnetic layer 14b. However, there is no member corresponding to the coupling soft magnetic layers 16a, 16b. Thus, the upper soft magnetic layer 24a and the lower soft magnetic layer 24b are not coupled by a soft magnetic body.

Accordingly, with reference to FIG. 12 (b), when the external magnetic field applied to the layered structure 2 (comparative example) is zero, the magnetization direction M2 has mutually opposing directions in the upper soft magnetic layer 24a and the lower soft magnetic layer 24b (−Z direction in the upper soft magnetic layer 24a and +Z direction in the lower soft magnetic layer 24b), and is stabilized in this state.

Here, when a magnetic field is applied externally to the layered structure 2 (comparative example) in the Z direction, it is necessary to break the magnetization (in the magnetization direction M2) stabilized in the Z direction and therefore, with reference to FIG. 13, there is an area where the magnetization M in the layered structure 2 (comparative example) is constant at zero (see the areas A1, A2 in FIG. 13), resulting in an area in which the magnetization M does not change linearly with respect to the external magnetic field H (see the areas A1, A2 in FIG. 13).

In accordance with the first embodiment, since the upper soft magnetic layer 14a and the lower soft magnetic layer 14b are connected through the coupling soft magnetic layer 16a and the coupling soft magnetic layer 16b, the magnetization direction M1 when the external magnetic field applied to the layered structure 1 is zero is stabilized in a direction perpendicular to the direction (the Z direction) in which the external magnetic field is applied.

Accordingly, even when a magnetic field may be applied externally to the layered structure 1 in the longitudinal direction Z, there is no need to break the stabilized magnetization (in the magnetization direction M1), and it is therefore possible to prevent the magnetization M in the layered structure 1 from becoming constant at zero.

It is noted that the first embodiment may include the following variations.

### <First Variation>

While both of the end face 120E1 and the end face 120E2 are exposed in the first embodiment, only one of them may be exposed.

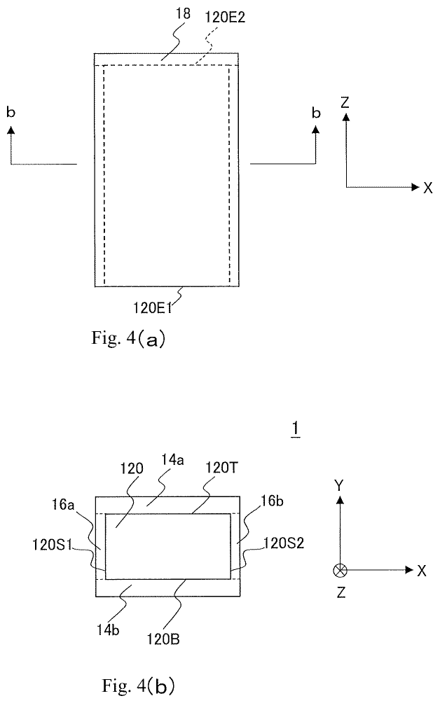

FIGS. 4 (a) and 4 (b) are a plan view (FIG. 4 (a)) and a b-b cross-sectional view (FIG. 4 (b)) of a layered structure 1 according to a first variation of the first embodiment. Note here that FIG. 4 (b) is the same as FIG. 1 (b).

The layered structure 1 according to the first variation of the first embodiment includes a soft magnetic layer 18 (of the same material as that of the upper soft magnetic layer 14a, the lower soft magnetic layer 14b, the coupling soft magnetic layer 16a, and the coupling soft magnetic layer 16b). The soft magnetic layer 18 covers the end face 120E2. The end face 120E2 is thus not exposed. The soft magnetic layer 18 may not cover the end face 120E2, but the end face 120E1. It is noted that components other than the soft magnetic layer 18 are identical to those in the first embodiment.

### <Second Variation>

The layered structure 1, while having a three-layer structure (including the upper soft magnetic layer 14a, the non-magnetic layer 120, and the lower soft magnetic layer 14b from the top) in the first embodiment, may have a five-layer structure (including an upper soft magnetic layer 14a, an uppermost non-magnetic layer 124, a soft magnetic layer 17, a lowermost non-magnetic layer 122, and a lower soft magnetic layer 14b from the top).

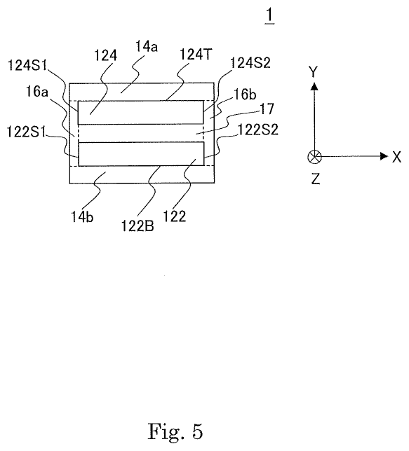

FIG. 5 is a b-b cross-sectional view of a layered structure 1 according to a second variation of the first embodiment. It is noted that FIG. 1 (a) should be referred to for the position of b-b.

The layered structure 1 according to the second variation of the first embodiment has an uppermost non-magnetic layer 124 and a lowermost non-magnetic layer 122 instead of the non-magnetic layer 120 according to the first embodiment. The uppermost non-magnetic layer 124 and the lowermost non-magnetic layer 122 are of the same material as that of the non-magnetic layer 120.

The upper soft magnetic layer 14a is in contact with a top surface 124T of the uppermost non-magnetic layer 124. The lower soft magnetic layer 14b is in contact with a bottom surface 122B of the lowermost non-magnetic layer 122. It is noted that the soft magnetic layer 17 is arranged between the uppermost non-magnetic layer 124 and the lowermost non-magnetic layer 122. The soft magnetic layer 17 is of the same material as that of the upper soft magnetic layer 14a, the lower soft magnetic layer 14b, the coupling soft magnetic layer 16a, and the coupling soft magnetic layer 16b.

Also, the coupling soft magnetic layer 16a is in contact entirely with a first side surface 124S1 of the uppermost non-magnetic layer 124. The coupling soft magnetic layer 16a is also in contact entirely with a first side surface 122S1 of the lowermost non-magnetic layer 122.

Further, the coupling soft magnetic layer 16b is in contact entirely with a second side surface 124S2 of the uppermost non-magnetic layer 124. The coupling soft magnetic layer 16b is also in contact entirely with a second side surface 122S2 of the lowermost non-magnetic layer 122.

That is, the coupling soft magnetic layers 16a, 16b are in contact entirely with the first side surfaces 122S1, 124S1 and the second side surfaces 122S2, 124S2.

It is noted that components other than above are identical to those in the first embodiment.

### <Third Variation>

The layered structure 1, while having a five-layer structure (including the upper soft magnetic layer 14a, the uppermost non-magnetic layer 124, the soft magnetic layer 17, the lowermost non-magnetic layer 122, and the lower soft magnetic layer 14b from the top) in the second variation of the first embodiment, may have a seven-or-more-layer structure (including an upper soft magnetic layer 14a, an uppermost non-magnetic layer 124, a soft magnetic layer 17, an intermediate non-magnetic layer 126, a soft magnetic layer 17, a lowermost non-magnetic layer 122, and a lower soft magnetic layer 14b from the top).

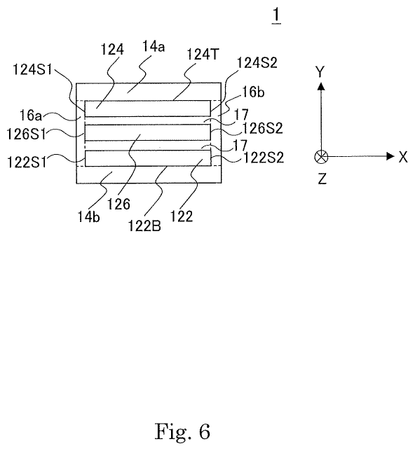

FIG. 6 is a b-b cross-sectional view of a layered structure 1 according to a third variation of the first embodiment. It is noted that FIG. 1 (a) should be referred to for the position of b-b.

The layered structure 1 according to the third variation of the first embodiment has an uppermost non-magnetic layer 124, a lowermost non-magnetic layer 122, and an intermediate non-magnetic layer 126 instead of the non-magnetic layer 120. The intermediate non-magnetic layer 126, the uppermost non-magnetic layer 124, and the lowermost non-magnetic layer 122 are of the same material as that of the non-magnetic layer 120.

The upper soft magnetic layer 14a is in contact with the top surface 124T of the uppermost non-magnetic layer 124. The lower soft magnetic layer 14b is in contact with the bottom surface 122B of the lowermost non-magnetic layer 122. It is noted that the intermediate non-magnetic layer 126 is arranged between the uppermost non-magnetic layer 124 and the lowermost non-magnetic layer 122. The intermediate non-magnetic layer 126 is also arranged between the soft magnetic layers 17. The soft magnetic layers 17 are of the same material as that in the second variation of the first embodiment.

Also, the coupling soft magnetic layer 16a is in contact entirely with a first side surface 124S1 of the uppermost non-magnetic layer 124. The coupling soft magnetic layer 16a is also in contact entirely with a first side surface 122S1 of the lowermost non-magnetic layer 122. The coupling soft magnetic layer 16a is also in contact entirely with a first side surface 126S1 of the intermediate non-magnetic layer 126.

Further, the coupling soft magnetic layer 16b is in contact entirely with a second side surface 124S2 of the uppermost non-magnetic layer 124. The coupling soft magnetic layer 16b is also in contact entirely with a second side surface 122S2 of the lowermost non-magnetic layer 122. The coupling soft magnetic layer 16b is also in contact entirely with a second side surface 126S2 of the intermediate non-magnetic layer 126.

That is, the coupling soft magnetic layers 16a, 16b are in contact entirely with the first side surfaces 122S1, 124S1, 126S1 and the second side surfaces 122S2, 124S2, 126S2.

It is noted that the intermediate non-magnetic layer 126 may include not only one but also two or more layers (forming a nine-or-more-layer structure in total). In this case, a soft magnetic layer 17 is arranged between the intermediate non-magnetic layers 126.

It is noted that components other than above are identical to those in the first embodiment.

### Second Embodiment

A second embodiment includes a toroidally-structured layered structure 1, which is different from the layered structure 1 according to the first embodiment.

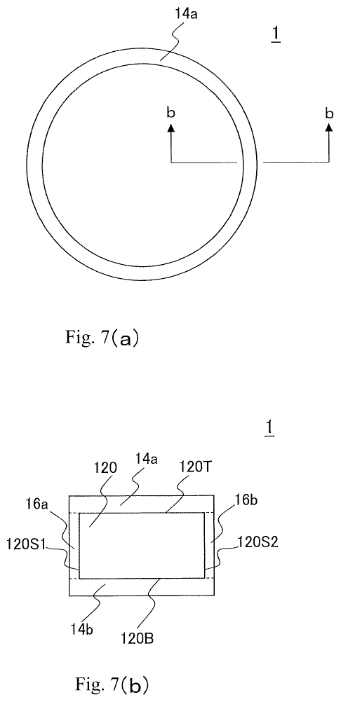

FIGS. 7 (a) and 7 (b) are a plan view (FIG. 7 (a)) and a b-b cross-sectional view (FIG. 7 (b)) of the layered structure 1 according to the second embodiment of the present invention. Note here that FIG. 7 (b) is the same as FIG. 1 (b).

The layered structure 1 according to the second embodiment extends in the longitudinal direction. Note here that the longitudinal direction in the second embodiment is curved (e.g. circular).

The layered structure 1 according to the second embodiment is annular. The first side surface 120S1 is arranged on the inner side. The second side surface 120S2 is arranged on the outer side. It is noted that components other than above are identical to those in the first embodiment.

The second embodiment exhibits the same advantageous effects as the first embodiment.

It is noted that the second embodiment may include the following variation.

### <Variation>

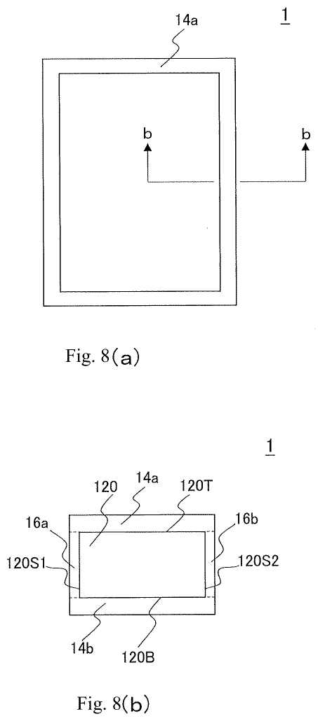

The layered structure 1, which is circular in the second embodiment, may have corners as long as it is annular. For example, the annular shape may be a polygon such as a triangle ring, a quadrilateral ring, a pentagon ring, . . . (the number of corners is optional). The quadrilateral ring may be, for example, a rectangular ring (as exemplified in FIG. 8).

FIGS. 8 (a) and 8 (b) are a plan view (FIG. 8 (a)) and a b-b cross-sectional view (FIG. 8 (b)) of a layered structure 1 according to a variation of the second embodiment. Note here that FIG. 8 (b) is the same as FIG. 7 (b). It is noted that components other than above are identical to those in the second embodiment.

### Third Embodiment

A third embodiment includes a toroidally-structured layered structure 1 (with discontinuity), which is different from the layered structure 1 according to the second embodiment.

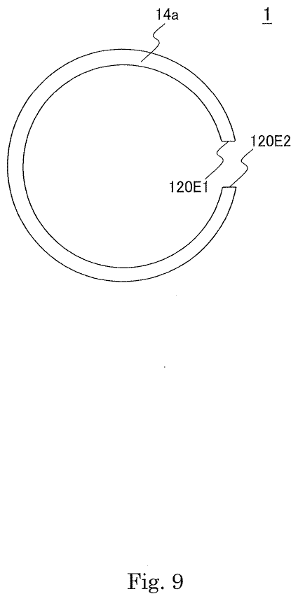

FIG. 9 is a plan view of a layered structure 1 according to the third embodiment of the present invention. A structure is shown in which the right-hand side of the layered structure 1 according to the second embodiment (see FIG. 7 (a)) is partially chipped. In the chipped portion, an end face 120E1 and an end face 120E2 are exposed, as is the case in the first embodiment. Note here that only one of the end face 120E1 and the end face 120E2 may be exposed, as is the case in the first variation of the first embodiment. It is noted that components other than above are identical to those in the second embodiment.

The third embodiment exhibits the same advantageous effects as the first embodiment.

It is noted that the third embodiment may include the following variation.

### <Variation>

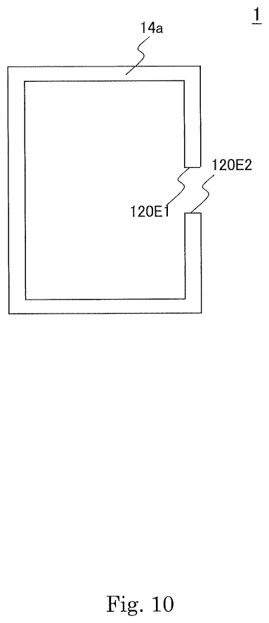

The layered structure 1, which is circular (with discontinuity) in the third embodiment, may have corners as long as it is annular. For example, the annular shape (with discontinuity) may be a polygon such as a triangle ring, a quadrilateral ring, a pentagon ring, . . . (the number of corners is optional). The quadrilateral ring (with discontinuity) may be, for example, a rectangular ring (with discontinuity) (as exemplified in FIG. 10).

FIG. 10 is a plan view of a layered structure 1 according to a variation of the third embodiment. The layered structure 1 is a rectangular ring (with discontinuity). It is noted that components other than above are identical to those in the third embodiment.

### Fourth Embodiment

A fourth embodiment includes a hole 13 that the coupling soft magnetic layer 16b has, which is different from the layered structure 1 according to the first embodiment.

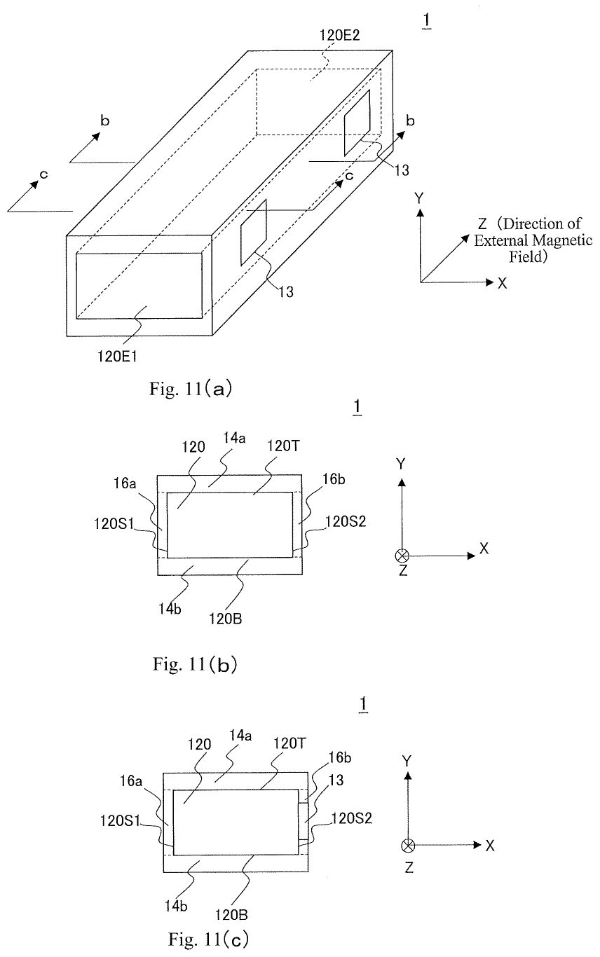

FIGS. 11 (b), 11 (b), and 11 (c) are a perspective view (FIG. 11 (a)), a b-b cross-sectional view (FIG. 11 (b)), and a c-c cross-sectional view (FIG. 11 (c)) of a layered structure 1 according to the fourth embodiment of the present invention. It is noted that FIG. 11 (b) is the same as FIG. 1 (b). The c-c cross-sectional view is taken on a portion of the layered structure 1 in which the hole 13 is provided along the XY plane. It is noted that components other than hole 13 are identical to those in the first embodiment.

Referring to FIGS. 11 (a) and 11 (c), the coupling soft magnetic layer 16b has the hole 13. Since the hole 13 penetrates the coupling soft magnetic layer 16b, a part of the second side surface 120S2 is exposed and visible externally. It is therefore considered that the coupling soft magnetic layer 16b is in contact partially (not entirely) with the second side surface 120S2. This also allows to exhibit the same advantageous effects as the first embodiment.

It is noted that the coupling soft magnetic layer 16a may have a hole 13 (that penetrates the coupling soft magnetic layer 16a). In this case, it is considered that the coupling soft magnetic layer 16a is in contact partially (not entirely) with the first side surface 120S1. This also allows to exhibit the same advantageous effects as the first embodiment.

Alternatively, the coupling soft magnetic layers 16a and 16b may each have a hole 13. In this case, it is considered that the coupling soft magnetic layer 16a is in contact partially (not entirely) with the first side surface 120S1 and the coupling soft magnetic layer 16b is in contact partially (not entirely) with the second side surface 120S2. This also allows to exhibit the same advantageous effects as the first embodiment.

The fourth embodiment exhibits the same advantageous effects as the first embodiment.

### DESCRIPTION OF REFERENCE NUMERALS

1 Layered Structure
120 Non-Magnetic Layer
120T Top Surface
120B Bottom Surface
120S1, 122S1, 124S1 First Side Surface
120S2, 122S2, 124S2 Second Side Surface
120E1, 120E2 End Face
122 Lowermost Non-Magnetic Layer
124 Uppermost Non-Magnetic Layer
126 Intermediate Non-Magnetic Layer
13 Hole
14a Upper Soft Magnetic Layer
14b Lower Soft Magnetic Layer
16a, 16b Coupling Soft Magnetic Layer
17, 18 Soft Magnetic Layer
2 Layered Structure (Comparative Example)
24a Upper Soft Magnetic Layer
24b Lower Soft Magnetic Layer
M1, M2 Magnetization Direction

What is claimed is:

1. A layered structure, comprising:
a non-magnetic layer;
an upper soft magnetic layer in contact with a top surface of the non-magnetic layer;
a lower soft magnetic layer in contact with a bottom surface of the non-magnetic layer; and
a coupling soft magnetic layer that is coupled to the upper soft magnetic layer and the lower soft magnetic layer, wherein
the coupling soft magnetic layer is in contact with a first side surface and a second side surface of the non-magnetic layer, and
the first side surface and the second side surface are spaced from each other.

2. The layered structure according to claim 1, wherein
the non-magnetic layer is a single layer.

3. The layered structure according to claim 1, wherein
the non-magnetic layer has an uppermost non-magnetic layer and a lowermost non-magnetic layer,
the upper soft magnetic layer is in contact with a top surface of the uppermost non-magnetic layer, and
the lower soft magnetic layer is in contact with a bottom surface of the lowermost non-magnetic layer.

4. The layered structure according to claim 1, wherein
the layered structure extends in a longitudinal direction, and
the longitudinal direction intersects both of a normal direction of the top surface or the bottom surface and a normal direction of the first side surface or the second side surface.

5. The layered structure according to claim 4, wherein
the longitudinal direction is linear.

6. The layered structure according to claim 4, wherein
the longitudinal direction is curved.

7. The layered structure according to claim 1, wherein
the layered structure is annular,
the first side surface is arranged on an inner side, and
the second side surface is arranged on an outer side.

8. The layered structure according to claim 1, wherein
the coupling soft magnetic layer is in contact entirely with the first side surface and the second side surface.

9. The layered structure according to claim 1, wherein
the coupling soft magnetic layer is in contact partially with the first side surface and the second side surface.

10. The layered structure according to claim 1, wherein
the non-magnetic layer has a plurality of end faces that intersect the top surface, the bottom surface, the first side surface, and the second side surface, and
any one or more of the end faces are exposed.

11. An inductor comprising the layered structure according to claim 1 used as a core.
